(19) United States
(12) Patent Application Publication
(10) Pub. No.: US 2011/0131198 A1
(43) Pub. Date: Jun. 2, 2011

(54) METHOD AND APPARATUS FOR PROVIDING A FILTER JOIN ON DATA STREAMS

(76) Inventors: THEODORE JOHNSON, New York, NY (US); Irina Rozenbaum, Pahoa, HI (US)

(21) Appl. No.: 12/627,079

(22) Filed: Nov. 30, 2009

(51) Int. Cl. G06F 17/30

(52) U.S. Cl. 707/714; 707/E17.054; 707/E17.017; 707/765; 707/E17.074

(57) ABSTRACT

A method and apparatus for processing at least one data stream are disclosed. For example, the method receives at least a join query for the at least one data stream, wherein the join query specifies a lifetime for keeping a tuple as a marker for a beginning of a sequence of interest, and receives a tuple from the at least one data stream. The method marks the tuple as a beginning of a sequence of interest and stores the tuple, if the tuple is the beginning of the sequence of interest. The method applies one or more initial predicates to the tuple, and determines if the tuple matched a marked tuple, if the tuple meets the one or more initial predicates. The method determines if the tuple meets one or more conditions to be outputted, if the tuple meets the one or more initial predicates conditions.

The present invention relates generally to data stream management systems and, more particularly, to a method for providing a filter join on data streams, e.g., on networks such as packet networks, Internet Protocol (IP) networks, and the like.

### BACKGROUND

Many applications such as network monitoring, financial monitoring, and scientific data feed processing, require complex processing of high speed data streams. A common type of query in these applications is a query to identify interesting tuples in a data stream specified by the query. In one example, a network analyst might want to collect all records in a network flow that start with a suspicious signature. In another example, a financial analyst might want to track trading records of a financial instrument following a suspicious trade. Evaluating these queries requires a join operator. However, a conventional join operator is costly to implement on a very high speed data stream.

### SUMMARY

In one embodiment, the present invention discloses a method and apparatus for processing at least one data stream. For example, the method receives at least a join query for the at least one data stream, wherein the join query specifies a lifetime for keeping a tuple as a marker for a beginning of a sequence of interest, and receives a tuple from the at least one data stream. The method marks the tuple as a beginning of a sequence of interest and stores the tuple in accordance with the lifetime specified in the join query, if the tuple is the beginning of the sequence of interest. The method applies one or more initial predicates to the tuple, and determines if the tuple matched a marked tuple, if the tuple meets the one or more initial predicates. The method determines if the tuple meets one or more conditions to be outputted, if the tuple meets the one or more initial predicates conditions, and outputs the tuple as a result to the join query if the tuple meets the one or more conditions to be outputted.

### BRIEF DESCRIPTION OF THE DRAWINGS

The teaching of the present invention can be readily understood by considering the following detailed description in conjunction with the accompanying drawings, in which:

FIG. 1 illustrates an exemplary Data Stream Management System (DSMS) architecture;

FIG. 2 illustrates an illustrative query plan for one and two data streams;

FIG. 3 illustrates a filter join evaluation model;

FIG. 4 illustrates a data summary structure for a hash table;

FIG. 5 illustrates a bloom filter data structure;

FIG. 6 illustrates a flowchart of the method of the current invention for providing filter join on data streams; and

FIG. 7 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing a filter join on data streams, e.g., data streams that traverse data networks such as packet networks, Internet Protocol (IP) networks and the like. However, it should be noted that the present invention is applicable to data streams in general, irrespective of the types of networks that the data streams are traversing over. For example, the present method is applicable to financial data streams, scientific data streams, data streams pertaining to users interacting with web sites, and the like.

Applications such as network monitoring, financial monitoring, sensor networks, and the processing of large scale scientific data feeds, produce data in the form of high-speed streams. Data streams are characterized as an infinite sequence of tuples that must be processed and analyzed in an on-line fashion to enable real-time responses. Data Stream Management Systems (DSMSs) are increasingly being used for query sets over high speed data steams. For example, a commonly used query is a query to select interesting records in a data stream. The selected interesting records may be reported to another system or may be used for more intensive analysis.

For example, in a network traffic analysis application, an analyst may wish to collect all packets from a suspicious Transmission Control Protocol (TCP) flow, where a flow is a collection of related records (or packets), in this case having the same source and destination. Often, the first packet in a flow contains information which identifies the application or protocol of the flow (DNS, RTP, HTTP, etc.). If the flow is found to be interesting, the analyst may wish to collect statistics, extract signatures, or simply collect all packets of the flow. In another example, a financial security application may collect and analyze trades with a suspicious pattern. For example, a security with a sudden increase in trading volume may be marked for intensive analysis, for arbitrage possibilities, etc. In another example, in a data stream from security video cameras, a sudden movement or anomalous movement by an object in view may trigger capture of all succeeding frames that contain the object for subsequent human analysis.

A query to select interesting records may be evaluated using a “Join query”: one input stream has the potentially “interesting” records, while the other identifies the keys of the interesting records. However, Join queries are often very expensive to evaluate since they require that two possibly high volume data streams be brought together in an operator in a time-synchronized manner. The join operator requires a large amount of buffering for the data streams. For example, a Symmetric Hash Join (SHJ) such as used in parallel database systems, requires in memory hash tables for both of its inputs during the query evaluation. Thus, the ability of an SHJ to sustain large inputs is severely limited. Another method allows data to overflow onto a disk. Accessing the overflow disks is prohibitively expensive for high speed data stream applications and is not feasible. Another approach is to perform load shedding to effectively reducing the amount of data. Load shedding has a negative implication on the accuracy of the query results.

The resource utilization may be reduced to some extent if the query is a self-join; this is because only one stream needs to be brought to the operator of a self-join and no synchronization is needed. Some queries (e.g., queries to find interesting flows) may be expressed as a self-join, to reduce the stress on the DSMS. However, a self-join on a data stream still remains a resource intensive operation, e.g., involving multiple hash tables with expiring entries. In practice, there are many applications that do not require such a heavy weight self-join operator.

In one embodiment, the current invention provides a filter join method for a class of self-join problems that obey the following pattern of evaluation:
Mark a record of a stream as a beginning of a sequence of record of interest;
Evaluate certain condition on every subsequent record of interest; and
Output only those records of a marked sequence that satisfy the condition.

In one embodiment, the pattern of evaluation may be regarded as a filtering procedure. The filter join operator of the current invention may have an efficient (inexpensive) implementation since its semantics are those of set membership. Using a filter join, one may answer the type of queries that select interesting records on data streams in an efficient and accurate manner.

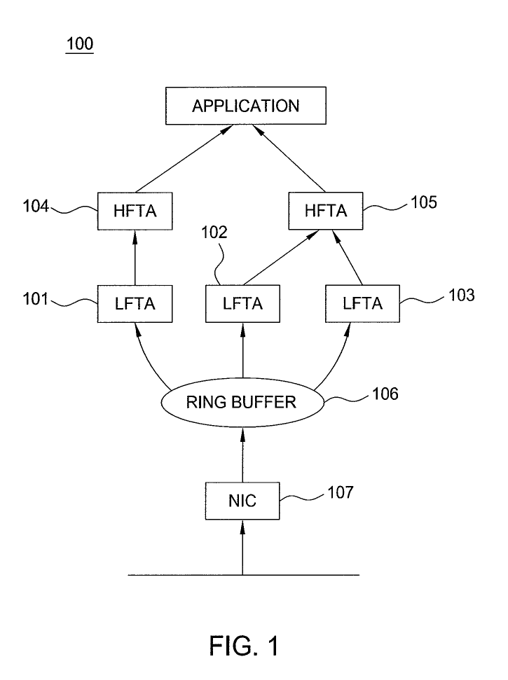

In order to clearly understand the current invention, an illustrative DSMS that may be used for IP network monitoring applications will first be described. FIG. 1 illustrates an exemplary DSMS architecture 100 that may be used for IP network monitoring applications. The DSMS architecture 100 has a multilevel architecture instead of an architecture based on load shedding techniques. For example, the DSMS may have a two-level query architecture in which a low level may be used for data reduction and a high level may be used to perform more complex analysis. Query nodes which are fed by a source data stream (e.g., packets sniffed from network interface) are called low level queries or LFTAs (Low-level Filter Transform Aggregates), while all other query nodes are called high level queries or HFTAs (High-level Filter Transform Aggregates). The high-low level approach allows the system to keep up with high speed streams in a controlled manner. For example, the DSMS architecture 100 comprises LFTAs 101, 102 and 103, and HFTAs 104 and 105.

For example, a low level filtering may be performed on the incoming high-speed data stream. In FIG. 1, data from a high speed data stream is first placed into a ring buffer 106 which is connected to the Network Interface Card (NIC) 107. The low-level queries 101-103 may then read records directly from the ring buffer 106, saving the cost associated with copying the data. The resulting filtered data may then be provided as an input to the higher level data analysis system 104 or 105.

Significant data reduction performed by the LFTAs 101-103 makes it possible to copy the filtered data stream to the HFTA level of query architecture for more complex processing. The low level queries are intended to be very fast and lightweight data reduction queries. The architecture allows the DSMS to defer costly processing until the data reaches high level of architecture (e.g., HFTA 104 or 105), which makes processing fast and minimizes buffer requirements. Depending on the capabilities of the NIC, some or all of the low query processing may be pushed farther down into the NIC itself. The goal of choosing the most effective strategy for query processing is to maximize the data reduction without overloading the LFTAs, where overloading the LFTAs may cause packets to be dropped, which in turn may lead to incomplete query results.

In one embodiment, the current method provides a filter join operator that outputs packets that satisfy a certain condition, by filtering out the rest of the packets of a flow. The filter join may also be referred to as a unidirectional case of a hash join operator. For example, the filter join operator may be used to find flows in which the payload of Hypertext Transfer Protocol (HTTP) response packets contains links to audio or video files. The output may then be only the packets of the flows that satisfy the condition.

In order for a filter join operator to output packets that satisfy a condition, the filter join operator follows a certain pattern of evaluation. For example, first the beginning of a flow may be marked. Every subsequent packet of the flow may then be evaluated on the desired condition. The packets that satisfy the desired condition may then be passed through for further analysis. In order to clearly illustrate the current method, the mathematical definition of the filter join operator is first provided.

Let,

R and S be two data streams;

A be a set of attributes associated with every tuple t_{R}∈R and tₛ∈S;

A_{key}⊂ A be a set of join attributes;

aₜ∈A , be a monotonic increasing attribute; and

c be a positive integer.

A filter join of the two streams is a subset of R defined by

$$\{ \begin{matrix}{t}_{R} ∈ R \vert {∃}_{{t}_{S} ∈ S} {t}_{R} \cdot {A}_{key} = {t}_{S} \cdot {A}_{key} and {t}_{R} \cdot {a}_{t} \geq {t}_{S} \cdot {a}_{t} \\ and {t}_{R} \cdot {a}_{t} \leq {t}_{S} \cdot {a}_{t} + c and {t}_{R} follows {t}_{S}\end{matrix} \} .$$

The advantage of the above definition is two-fold. First, it has an efficient implementation. The method only needs to store tuples of S to perform the join; tuples of R are streamed out if there is a matching tuple of S. In most cases, S will be much smaller than R, minimizing the memory footprint size. If the join is a self-join, then no tuple buffering is required to synchronize R and S. The second advantage is the definition of the filter join matches the needs of queries in which the goal is to find tuples in a stream that have been marked as interesting.

With the above mathematical definition of filter join, the method defines an operator FILTER JOIN that follows the self-filtering pattern of evaluation described above.

For example, the FILTER JOIN operator may be used to formulate a query for the audio/video links search problem described above as follows:

```
Query 1
Select R.time, R.srcIP, R.srcPort, R.destPort,
    R.sequence_number, R.ack_number,
    Str_regex_match(‘.(aac|ac3|aif|aiff|asf|avi|
    mpeg|mp1|mp2|mp3|mp4|mpv|ogg|ogm|omf|qt|
    rm|ram|swf|vob|wav|wma|wmv)’,
    R.TCP_data) as header
FILTER JOIN TCP as R, TCP as S
WHERE
    R.srcIP = S.srcIP AND
    R.destIP = S.destIP AND
    R.srcPort = S.SrcPort AND
    R.destPort = S.destPort AND
    R.protocol = 6 AND
    S.protocol = 6 AND
    R.data_length <> 0 AND
    S.data_length <> 0 AND
    Str_match_offset(‘HTTP’,S.TCP_data,0) AND
    Str_regex_match(‘.(aac|ac3|aif|aiff|asf|avi|
    mpeg|mp1|mp2|mp3|mp4|mpv|ogg|ogm|omf|qt|
    rm|ram|swf|vob|wav|wma|wmv)’,
    R.TCP_data) AND
    R.time < S.time + 10
```

The first four conditions of the WHERE clause above specify the join key attributes, while the next four predicates define the two joining streams R and S. Query 1 finds all packets in S that start with a string “HTTP”. It also matches the regular expression specified as an argument to the str_regex_match( ) function to every packet of R, thus ensuring that the payload contains at least one reference to a file with a known audio or video file extension. The last condition of the query specifies the liveliness of the S tuples: in this example, the tuples expire after 10 seconds of their arrival. The str_regex_match predicate is expensive and one would prefer to evaluate it on the minimum possible size set of tuples. A valuable optimization is to first perform the inexpensive filter join, and then perform the expensive str_regex_match predicate.

In one embodiment, the FILTER JOIN operator may be used to formulate a query on two streams R and S. Query 2 below provides an example of the general form of a join query on the two streams. In this query, time is a monotonically increasing attribute that defines the tuple's timestamp. A is a set of all tuple attributes (time, a₁, a₂, . . . , aₙ), and A_{key} is a subset of A that contains only attributes (aᵢ, aᵢ₊₁, . . . , aⱼ) that constitute the join key:

```
Query 2:
SELECT R.time,R.a₁,R.a₂,K , R.aₙ,
    S.time,S.a₁,S.a₂,K ,S.aₙ
JOIN TCP₁ as R,TCP₂ as S
WHERE
      Join key predicates
      f(R) = g(S) AND
      Complex predicates on both relations
      P_{cmp}(R,S) AND
      Cheap single relational predicates
      P_{ch}(R) and P_{ch}(S) AND
      Expensive single relational predicates
      Pₑ(R) and Pₑ(S) AND
      Predicates on temporal attributes
      Pₜ(R.time,S.time)
```

The initial join key predicates in the WHERE clause of the query above can be as simple as defining equality of the two join attributes, e.g. R.aᵢ=S.aᵢ. The predicates may also be expressed as a function applied to any or all of the join attributes of a tuple. For example, complex predicates on both relations might include predicates like R.aᵢ>S.aᵢ+1. Single relational predicates are often cheap to evaluate; they might be similar to R.aᵢ=cons tan t. In other cases, they might be more expensive to evaluate, for example invoking expensive functions such as regular expression matching. The last condition of the query on temporal attributes might look like R.time IN [S.time,S.time+c] or R.time≦S.time+c where c is some constant that defines the lifetime of a Tuple.

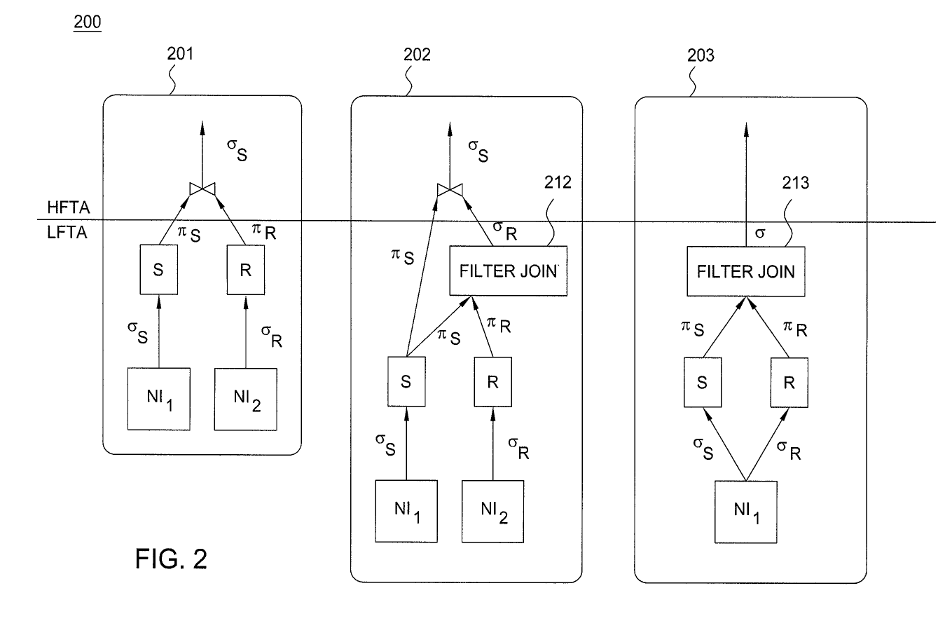

FIG. 2 illustrates an illustrative query plan 200 for one and two data streams that can be fully evaluated by a symmetric join operator at HFTA level of a DSMS. For example, query plan 201 shows the plan for joining two data streams that have two different data sources TCP₁ and TCP₂. The number of tuples that would have to be copied from LFTA to HFTA in order to evaluate the query can be very large, considering that each of the data streams may produce tens or even hundreds of thousands of tuples per second. This query plan is likely to be expensive due to both the join and the tuple copying costs.

A query plan 202 has both streams go through filter join 212 at LFTA level of the DSMS, and a significantly reduced amount of traffic is channeled to the HFTA level for completion of the query evaluation.

In practice, it is often possible to further optimize the query plan and make the query evaluation more efficient based on certain additional information about the data source. For example, if one knows that both S and R have the same data source, the query evaluation may be completed using only the filter join operator 213 at the LFTA level of the DSMS, as shown in query plan 203.

Pushing a filter join operator as close as possible to the data source is an important optimization step since doing so minimizes data movement in the DSMS. For example, early data reduction may be performed by pushing operators into the LFTA level. For distributed stream systems, pushing filter joins to the data sources may significantly reduce data transmission costs.

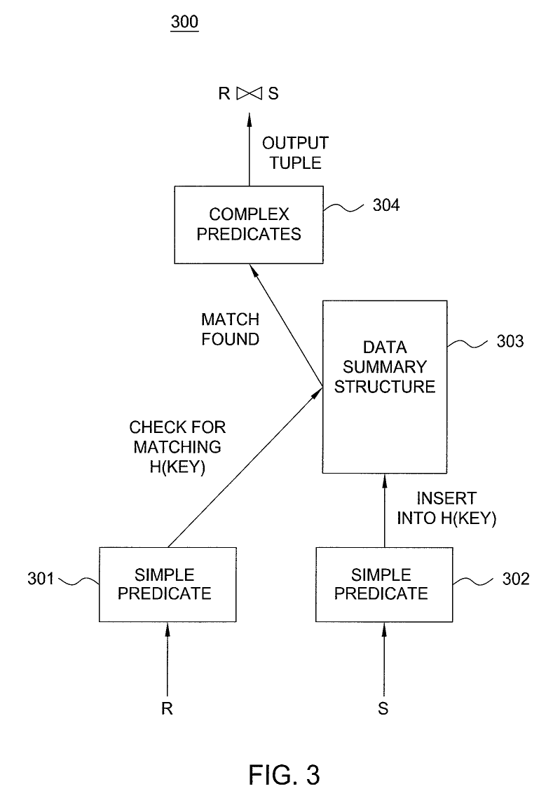

FIG. 3 illustrates an exemplary filter join evaluation model 300. In one embodiment, the filter join evaluation model 300 comprises simple predicates 301 and 302, data summary structure 303, and complex predicate 304. The filter join operates as a set membership test in which elements expire from the set over time. When a tuple arrives, it is first evaluated on the simple single-relational predicate 301 or 302 specified by the query. If it does not satisfy the conditions in the simple predicate, the tuple is discarded. When a tuple from the S stream passes the predicate 302, it is hashed into the data summary structure 303. If an arriving tuple belongs to the R relation, the hashed value of its join attributes is compared with the tuple of S that has an identical hash key, H(key), within the data structure, if such exists. If a matching S tuple is found, the tuples are evaluated on the complex single-relational predicates 304. When all of the conditions are satisfied, the output tuple is produced. The current method performs the filter join query evaluations described above with assumptions on tuple ordering and outputting only distinct join tuples as described below.

In one embodiment, the arriving tuples have synchronized timestamps. When evaluating filter join of the two streams R and S, the method considers a tuple from R to be a valid candidate for filter join only if its timestamp is greater than the timestamp of the tuple from S. Tuples from S stream can be in advance of tuples from the R stream, however tuples from R stream are never in advance of the tuples from S stream. Formally defined, S.time≦R.time if and only if R arrives after S. In the case of a self-join, this synchronization occurs automatically. For other cases, the method assumes that there is a module which performs any necessary buffering before tuples are processed by the filter join.

For the second assumption, in the presence of many tuples from S with identical join key attributes and valid timestamps, one possible approach would be to store all such tuples of S in the data summary structure and iterate through this list for every arriving R tuple with the matching hash value. However, this approach could require a considerable amount of memory to maintain tuples from S and would potentially be too slow and unable to keep up with high-speed data streams. Therefore, the method only stores tuples of S with distinct key values in the data summary structure. In other words, queries that perform filter join have an implicit DISTINCT in their SELECT clause and only distinct join tuples are produced in the output.

In one embodiment, the current method also performs query transformations that take advantage of filter joins at the lower level of a query plan while performing the rest of the data analysis at the higher level. A query has to satisfy some conditions to be executed with the filter join operator described above. Given a join query, e.g., Query 2, the method determines whether or not the query can be evaluated using a filter join by checking if it meets the following conditions:
No attributes of S appear in the select clause, except for S.time;
P_{cmp}(R,S) is empty (i.e. has the value TRUE);
The predicate of the temporal attribute is of the form R.time IN [S.time,S.time+c] and either R.time and S.time are strictly increasing or there is a predicate equivalent to “R follows S”.

In order to achieve better performance, the amount of memory used by the filter join operator must be reasonably small. Therefore, the data summary structure, e.g., data summary structure 303 of FIG. 3, maintains only a restricted set of S tuple attributes. The restricted set of S tuple attributes includes all of the attributes that constitute the join key a∈A_{key} and the timestamp of a tuple S time.

The fact that the method maintains only a restricted set of attributes for tuples from S makes the query processing more involved when the query references attributes other than the join key attributes or the time attribute of S tuples in its SELECT clause. Such cases may require query decomposition when part of the query is processed at the filter join and is completed with another conventional join.

For example, Query 3 provided below cannot be processed efficiently at LFTA level, since the SELECT clause contains a reference to an attribute which is not a part of the restricted set of attributes of S maintained by the data summary structure.

```
Query 3:
SELECT S.aⱼ₊₁
JOIN R,S
WHERE
    f(R) = g(S) AND
    P_{ch}(R) and P_{ch}(S) AND
    Pₑ(R) AND
    Pₜ(R.time,S.time)
```

In order to process query 3 efficiently, the method needs to decompose the join query 3. One possibility for the decomposition is to decompose the join query 3 into HFTA and LFTA levels as follows:

```
Query 4.1, HFTA:
SELECT S.aⱼ₊₁
JOIN R_source as R, S_source as S
WHERE
    f(R) = g(S) AND
    Pₜ(R.time,S.time)
Queries 4.2 and 4.3, LFTA:
DEFINE query_name R_source
SELECT time,aᵢ,aᵢ₊₁,K ,aⱼ
FROM R
WHERE P_{ch}(R) and Pₑ(R)
DEFINE query_name S_source
SELECT time,aᵢ,aᵢ₊₁,K ,aⱼ
FROM S
WHERE P_{ch}(S)
```

The query sets above perform the join of the two streams at the HFTA level (Query 4.1), and the only processing that is done at LFTA is a simple SELECT filtering. However, it may be likely that this decomposition is not sufficiently efficient on high-speed streams; as mentioned before, one would like to push the join operation as far down the system architecture as possible. A more efficient way of splitting the query for high-speed streams is as follows:

```
Query 5.1, HFTA:
SELECT S.aⱼ₊₁
JOIN R_source as R, S_source as S
WHERE
        f(R) = g(S) and
    Queries 5.2 and 5.3, LFTA:
    DEFINE query_namr R_source
    SELECT time,aᵢ,aᵢ₊₁,K ,aⱼ
    FILTER JOIN R,S
    WHERE
            f(R) = g(S) AND
            P_{ch}(R) and P_{ch}(S) AND
            Pₑ(R) AND
            Pₜ(R.time,S.time)
```

The above decomposition performs filter join at LFTA level and symmetric hash join at HFTA level which outputs the desired value of the S.aⱼ₊₁ attribute. If S_source is highly selective (which is often the case in practice), evaluating Query 5.1 is a low-cost operation.

The decomposition examples described above deal with the case where the SELECT clause of the query references an attribute S.aⱼ₊₁, that is not a temporal attribute or a part of the join key. In cases where such attribute is referenced by any of the single relational predicates, the query can be evaluated at LFTA level without any decomposition. That is because the value of the attribute is known at the time of S tuple processing and has no dependency on any of the attributes of R. When a non-temporal, non-join key attribute is referenced in complex predicates on both relations, query evaluation becomes more complex and may also require decomposition.

For example, consider the following predicate: R.aᵢ>S.aⱼ. This predicate references the aⱼ attribute of S, which belongs to the set of the join key attributes (S.aⱼ∈S.A_{key}). When evaluating a query with this predicate, the value of S.aⱼ can be retrieved from the data summary structure and the predicate can be evaluated at the LFTA level before the output tuple is produced. On the other hand, if the predicate is R.aⱼ₊₁>S.aⱼ₊₂ where, Saⱼ₊₂ ∉S.A_{key} the query needs to be decomposed as follows:

```
Query 6.1, HFTA:
SELECT S.aⱼ₊₂
JOIN R_source as R, S_source as S
WHERE
    f(R) = g(s) AND
    P_{cmp}(R,S)
Queries 6.2 and 6.3, LFTA:
DEFINE query_name R_source
Select time,aᵢ,aᵢ₊₂,K , aⱼ
FILTER JOIN R,S
WHERE
    f(R) = g(S) AND
    P_{ch}(R) and P_{ch}(S) AND
    Pₑ(R) and Pₑ(S) AND
    Pₜ(R.time,S.time)
DEFINE query_name S_source
SELECT time,aᵢ,aᵢ₊₂,K ,aⱼ,aⱼ₊₂
FROM S
```

For the query transformation analysis above, the only attributes of S that can appear in the SELECT clause of the query or as a part of its complex predicates on both relations, are either the attributes S.a∈S.A_{key} that constitute the join key of the query, or the temporal attribute(s).

For some applications, the cost of performing a complex single-relational predicate may be substantial. For example, when a query contains both Pₑ(R) and Pₑ(S) in the general case of query execution using filter join operator, the two predicates would be evaluated on every tuple produced by the join. This evaluation may significantly increase the per-tuple time processing. Since the output of a filter join is expected to be much smaller than the input, the method may push the evaluation of the complex predicates after the join.

For example, the filter join model of FIG. 3 has a module for evaluating Pₑ(R). To optimize the processing of Pₑ(S), the method can push the evaluation of Pₑ(S) up the query evaluation plan, thus making the query evaluation faster. If, for example, the evaluation of Pₑ(S) requires knowing the value of attribute S.aⱼ₊₁∉A_{key}, the query transformation becomes similar to query set 6 as shown below.

```
Query 7.1, HFTA:
SELECT S.aⱼ₊₂
JOIN R_source as R, S_source as S
WHERE
    f(R) = g(S) AND
    P_{cmp}(R,S) AND
    Pₑ(S)
Queries 7.2 and 7.3, LFTA
DEFINE query_name R_source
Select time,aᵢ,aᵢ₊₂,K ,aⱼ
FILTER JOIN R,S
WHERE
    f(R) = g(S) AND
    P_{ch}(R) and P_{ch}(S) AND
    Pₑ(R) AND
    Pₜ(R.time,S.time)
DEFINE query_name S_source
SELECT time,aᵢ,aᵢ₊₂,K ,aⱼ,aⱼ₊₂
FROM S
```

The query 7 above has to satisfy the following condition to be executed by the filter join operator: A filter join query may not contain any complex single relational predicates Pₑ(S) of S; and all such predicates are pushed up in the query evaluation plan.

Returning back to query 2, the last condition of the WHERE clause defined by Query 2, is a predicate on a temporal attribute of the two streams. Such a predicate bounds the range of tuples that can be potentially joined. For example, the predicate R.time IN [S.time,S.time+c], joins only those tuples of R that arrive within c seconds of the last tuple seen from S. Queries with such a predicate can be fully evaluated by the filter join operator by requiring the filter join procedure to consider only those tuples of S in the data summary structure for which S.time≦R.time, where R.time is the timestamp of the currently processed tuple of stream R.

Another example of predicates on temporal attributes that can be fully evaluated in a very similar manner by the filter join operator include R.time IN[S.time+c₁, S.time+c] where c₁>0 and c₂>0 are constants such that cᵢ<c₂.

A temporal predicate can also be of the form R.time in [S.time−c,S.time+c]. This case is different from the ones just discussed above. In this case, the method seeks to capture all tuples of R such that they appear within ±c seconds of the matching tuple from S. To evaluate a query with such predicate, again the method needs to split it between the two levels (HFTA and LFTA) of architecture as shown below.

```
Query 8.1, HFTA
MERGE R.time : S.time
FROM after as R, before as S
Queries 8.2 and 8.3, LFTA:
DEFINE query_name after
SELECT R.time, R.aᵢ,R.aᵢ₊₁,K R.aⱼ
FILTER JOIN R,S
WHERE
    f(R) = g(s) AND
    P_{ch}(R) and P_{ch}(S) AND
    Pₑ(R) AND
    R.time in [S.time,S.time + c]
DEFINE query_name before
SELECT R.time,R.aᵢ,R.aᵢ₊₁,K ,R.aⱼ
FILTER JOIN S,R
WHERE
    f(R) = g(s) AND
    P_{ch}(R) and P_{ch}(S) AND
    Pₑ(R) AND
    S.time in [R.time,R.time + c]
```

The query “after” (shown in query 8.2) takes care of the [S.time, S.time+c] part of the time interval specified by the predicate, while the query “before” (shown in query 8.3) captures tuples of R that fall into the [S.time−c, S.time] part of the time interval by transforming the predicate into the form S.time in [R.time, R.time+c] acceptable by the filter join operator. The two streams of tuples are later merged together at HFTA level of query processing.

Formalizing the above analysis, a query must satisfy the following condition in order to be executable by the filter join operator: The temporal predicate that defines the liveliness of tuples from S can only refer to time intervals starting with the most recently seen S.time. In other words, the time interval such predicate describes must be of a form equivalent to [S.time, S.time+c] where c>0.

In one embodiment, the filter join query described above has the following general form:

```
Query 9:
SELECT R.time,R.a₁,R.a₂,K R.aₙ,
      S.time,S.aᵢ,S.aᵢ₊₁,K ,S.aⱼ
FILTER JOIN TCP as R, TCP as S
WHERE
    f(R) = g(s) AND
    P_{ch}(R) and P_{ch}(S) AND
    Pₑ(R) AND
    Pₜ(R.time,S.time)
```

As noted above, in order for the filter join operation to be efficient, it is essential that it consumes a limited amount of memory and that the per-tuple time processing is small. The filter join may be implemented using a conventional hash join with excellent efficiency. However, an advantage of the simple semantics of the filter join (i.e., set membership) is that it readily lends itself to approximate algorithms.

In one embodiment, the current method provides an approximate filter join algorithm using two different data structures: one with negative errors but no positive errors (using a fixed-size hash table) and another with positive errors but no negative errors (using Bloom filters). Negative errors are acceptable in many cases, and positive errors may often be filtered out.

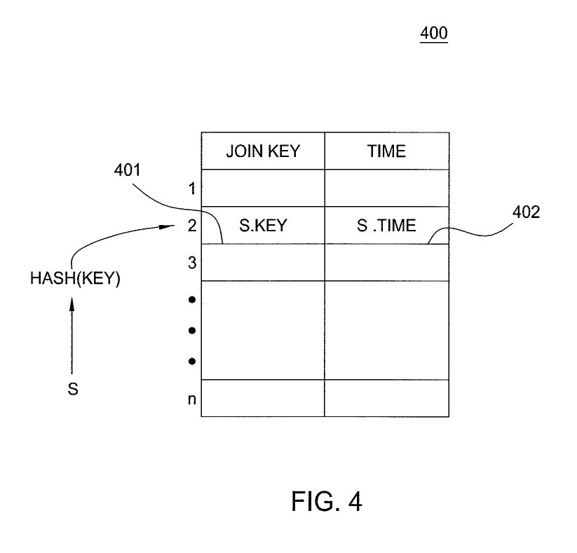

The first approximate method for filter join algorithm implements the filter join with a hash table used as the data summary structure. FIG. 4 illustrates a data summary structure 400 for a hash table. The hash key for the data summary structure 400 is the set of join attributes of a tuple S.A_{key} 401. The value is the arriving time 402 of the tuple S.time.

In practical applications, memory reallocation is an expensive operation strongly discouraged at the LFTA levels. Hence, the size of the hash table has to be known at the initialization, and therefore the join key attributes only contain either numeric value attributes or constant size string attributes.

In one embodiment, the algorithm uses a second chance probing mechanism in case of hash table insertion collisions: whenever the slot of the hash table is occupied by a valid tuple that has a different set of join key attributes than the one being processed, the next slot of the table is probed for insertion. If that slot is also occupied with a valid tuple, the method may perform one of the following approaches for collision handling:
(1) evict the oldest tuple from the two slots considered for insertion and insert the current tuple in its place; or
(2) drop the current tuple and proceed to the next tuple.

In one embodiment, the procedure of the algorithms for performing filter join with a hash table is as follows:

Let S_{c} be the tuple of S being currently processed, and let Sₕ be a tuple of S previously inserted into the hash table.

```
On the arrival of S_{c} :
if S_{c}satisfies P_{ch}(S_{c}) then
    slot = hash(S_{c},A_{key})
    if slot has valid Sₕ and Sₕ.key == S_{c}.key then
        Sₕ.time = S_{c}.time
    else if slot contains Sₕ then
        replace Sₕ with S_{c} in slot
    else if slot is empty then
        insert S_{c} into slot
    else use approach 1 or 2 for collision handling
On the arrival of R:
if R satisfies P_{ch}(R) then
    slot = hash(R.A_{key})
    if slot contains valid Sₕ and Sₕ.A_{key} == R.A_{key} then
        if R satisfies Pₑ(R) and then
            return R
```

The above implementation of filter join may produce false negatives if tuples of R and S are not joined due to hash collisions. However, there are no false positives.

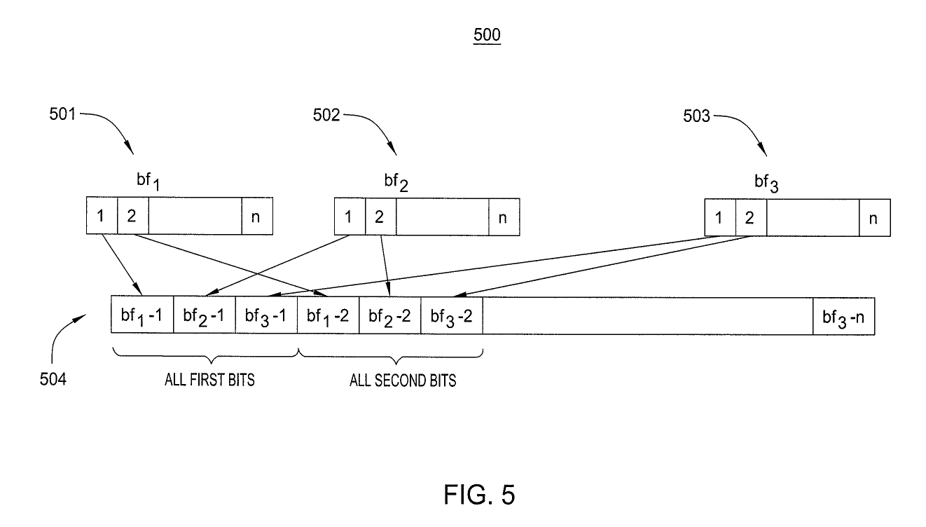

In one embodiment, the second approximate method for filter join algorithm uses a set of bloom filters. FIG. 5 illustrates an exemplary bloom filter data structure 500. The bloom filter data structure 500 contains three bloom filters 501, 502 and 503. Each of the bloom filters 501-503 has size n bits, and corresponds to a single time unit of the liveliness time interval of S. In other words, if B is the set of bloom filters, and the temporal predicate is R.time in [S.time,S.time+c], there would be c filters in B, i.e. |B|=c. To preserve cache locality and ensure efficient memory access, all of the bloom filters are arranged into a single bit array in which all ith bits of the filters are grouped together in 504.

In one embodiment, a set H of hash functions is used to set bits in the bloom filter which corresponds to the time unit of each arriving tuple from S. The hash key is the set of the join attributes S.A_{key}, and the value of the hash functions is the bit index[0, 1, . . . , n−1]. When a tuple from S is inserted, the hash function values are calculated and the appropriate bits in the corresponding bloom filter are set.

When a tuple from R arrives, the method calculates the corresponding bloom filter bit numbers and check whether the same bits are set in any of the bloom filters, in which case (if all other conditions are met) an output tuple is produced. The Bloom filters are used in a circular manner: with the arrival of the first tuple t (whether it belongs to S or R) in a new time unit, the bloom filter with the index [bf=t.time mod|B|] is first zeroed out, and then the bits corresponding to the tuple are set.

An exemplary detailed pseudo code for handling S and R tuples is as follows:

```
On the arrival of S:
bf = S.time mod|B|
if S satisfies P_{ch}(S) then
    for each Hᵢ do
        SET _BIT(B_{bf},Hᵢ(S.A_{key}))
On the arrival of R:
bf = R.time mod|B|
zero out Bloom Filter B_{bf}
if R satisfies P_{ch}(R) then
    for each Bᵢ do
        for each H ⱼ do
            if IS _SET(Bᵢ,H ⱼ,(R.A_{key}))
                count _set + +
                else
                    count _set = 0
                    break
          if count _set == |H|
                found = 1
                count _set = 0
                break
          else
                count _set = 0
        if found == 1
          if R satisfies Pₑ(R) then
                return R
```

In one embodiment, the above bloom filter data structure algorithm is prone to producing false positives (but no false negatives) when an output tuple is created as a result of two different join key sets setting the same bit within a Bloom filter, i.e. Hᵢ(S.A_{key1}=Hⱼ(S.A_{key2}). This could be remedied, and it may even be considered an advantage over having false negatives, when filter join is used as a preliminary filtering procedure whose results are fed into a more sophisticated, heavy-weight analysis at the higher level of query processing.

In one embodiment, the current method provides a multilevel architecture for performing filter joins on data streams comprising one or more Low-level Filter Transform Aggregate (LFTA) queries and/or High-level Filter Transform Aggregate (HFTA) queries. The LFTAs are intended to be very fast and lightweight data reduction queries. The architecture then allows the method to defer costly processing until the data reaches the high level of architecture. For example, a low level filtering may be performed on the incoming high-speed data stream by first marking the beginning of a flow and then evaluating every subsequent packet of the flow on the desired condition. The resulting filtered data may then be provided as an input to the higher level data analysis system. For example, the packets that satisfy the desired condition at the low level may then be passed through for further analysis to the higher level.

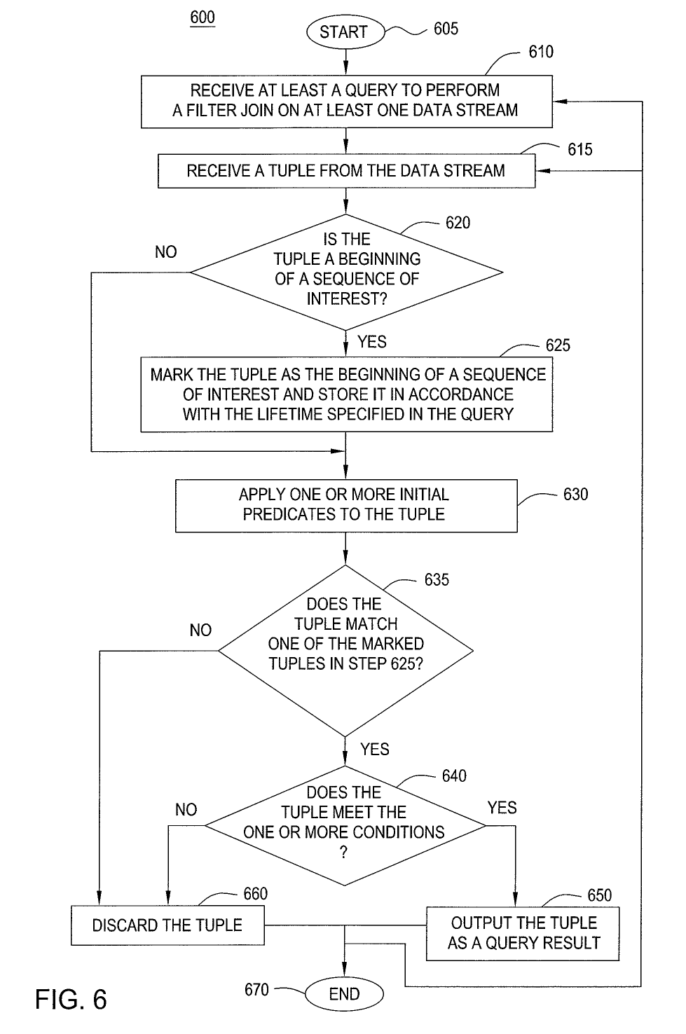

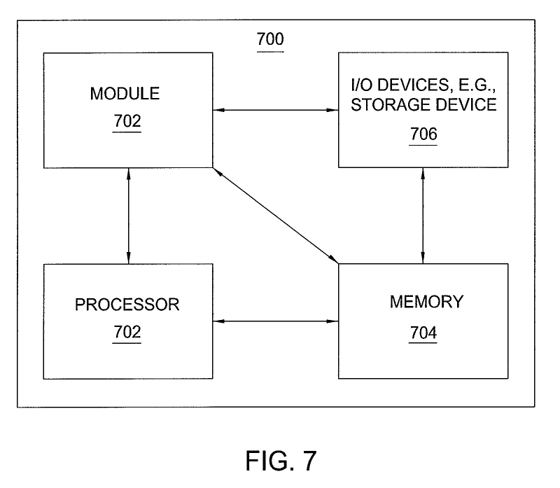

FIG. 6 provides a flowchart of a method 600 for providing filter join queries on data streams. In one embodiment, method 600 can be implemented by a data stream management system or a general purpose computer as illustrated in FIG. 7. Method 600 starts in step 605 and proceeds to step 610.

In step 610, method 600 receives at least a query to perform a filter join on at least one data stream, wherein the join query specifies a lifetime for keeping a tuple as a marker for a beginning of a flow. For example, the method receives a filter join query to output tuples from a data stream that meet a predetermined list of requirements. The query also specifies a lifetime, e.g., 10 seconds, 20 seconds, etc., for keeping a tuple as a marker.

In step 615, method 600 receives a tuple from the data stream. For example, the method receives a tuple from a high-speed data stream from which tuples that meet the above predetermined list of requirements are to be outputted.

In step 620, method 600 determines if the tuple is a beginning of a sequence of interest. For example, the method determines if the tuple is the first tuple for a new sequence of interest that may be outputted. If the tuple is a beginning of a sequence of interest, the method proceeds to step 625. Otherwise, the method proceeds to step 630.

In step 625, method 600 marks the tuple as the beginning of a sequence of interest if the tuple is a beginning of a sequence of interest and stores the tuple in accordance with the lifetime specified in the query. The method then proceeds to step 630.

In step 630, method 600 applies one or more initial predicates to the tuple. The method then proceeds to step 635.

In step 635, method 600 determines if the tuple matches one of the marked tuples that have been stored in step 625. If there is a match, the method proceeds to step 640. Otherwise, the method proceeds to step 660.

In step 640, method 600 determines if the tuple meets one or more conditions (e.g., additional selection condition) to be outputted. For example, the method determines if the tuple meets all the criteria to be outputted as a response to the join filter query. If the tuple meets the one or more conditions to be outputted, the method proceeds to step 650. Otherwise, the method proceeds to 660.

In step 650, method 600 outputs the tuple as a query result. For example, the method provides the tuple as one that meets the join query request. The method then ends in step 670 or returns to either step 610 or step 615 to continue receiving more queries or more tuples, respectively.

In step 660, method 600 discards the tuple. For example, the tuple does not meet the conditions to be outputted as a response to the query. The method then ends in step 670 or returns to either step 610 or step 615 to continue receiving more queries or more tuples, respectively.

It should be noted that although not specifically specified, one or more steps of method 600 may include a storing, displaying and/or outputting step as required for a particular application. In other words, any data, records, fields, and/or intermediate results discussed in the method 600 can be stored, displayed and/or outputted to another device as required for a particular application. Furthermore, steps or blocks in FIG. 6 that recite a determining operation, or involve a decision, do not necessarily require that both branches of the determining operation be practiced. In other words, one of the branches of the determining operation can be deemed as an optional step.

FIG. 7 depicts a high-level block diagram of a general-purpose computer suitable for use in performing the functions described herein. As depicted in FIG. 7, the system 700 comprises a processor element 702 (e.g., a CPU), a memory 704, e.g., random access memory (RAM) and/or read only memory (ROM), a module 705 for providing a filter join on data streams, and various input/output devices 706 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 705 for providing a filter join on data streams can be loaded into memory 704 and executed by processor 702 to implement the functions as discussed above. As such, the present method 705 for providing a filter join on data streams (including associated data structures) of the present invention can be stored on a computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for processing at least one data stream, comprising:
receiving at least a join query for the at least one data stream, wherein said join query specifies a lifetime for keeping a tuple as a marker for a beginning of a sequence of interest;
receiving a tuple from the at least one data stream;
marking said tuple as a beginning of a sequence of interest and storing said tuple in accordance with the lifetime specified in said join query, if said tuple is said beginning of said sequence of interest;
applying one or more initial predicates to said tuple;
determining if said tuple matched a marked tuple, if said tuple meets the one or more initial predicates.
determining if said tuple meets one or more conditions to be outputted, if said tuple meets said one or more initial predicates conditions; and
outputting said tuple as a result to said join query if said tuple meets said one or more conditions to be outputted.

2. The method of claim 1, further comprising:
optimizing the join query based on information pertaining to a data source.

3. The method of claim 2, wherein said information pertaining to said data source comprises that two or more data streams of said at least one data stream having a same data source.

4. The method of claim 1, further comprising:
performing one or more query transformations such that said join query is performed by said one or more low level queries, while a complex analysis is performed by said one or more high level queries.

5. The method of claim 1, further comprising:
decomposing said join query if said join query contains a reference to one or more attributes which are not part of a restricted set of attributes of a data stream maintained by a data summary structure.

6. The method of claim 5, wherein said decomposing of said join query is performed to use a filter join at said one or more low level queries and a symmetric hash join at said one or more high level queries.

7. The method of claim 1, wherein each of said one or more low level queries applies a filter join that is implemented using a hash join algorithm or an approximate filter join algorithm.

8. The method of claim 7, wherein said approximate filter join algorithm uses a hash table or a bloom filter as a data summary structure.

9. The method of claim 8, further comprising:
performing collision handling if a slot of said hash table is occupied by a valid tuple.

10. A computer-readable storage medium having stored thereon a plurality of instructions, the plurality of instructions including instructions which, when executed by a processor, cause the processor to perform steps of a method for processing at least one data stream, comprising:
receiving at least a join query for the at least one data stream, wherein said join query specifies a lifetime for keeping a tuple as a marker for a beginning of a sequence of interest;
receiving a tuple from the at least one data stream;
marking said tuple as a beginning of a sequence of interest and storing said tuple in accordance with the lifetime specified in said join query, if said tuple is said beginning of said sequence of interest;
applying one or more initial predicates to said tuple;
determining if said tuple matched a marked tuple, if said tuple meets the one or more initial predicates.
determining if said tuple meets one or more conditions to be outputted, if said tuple meets said one or more initial predicates conditions; and
outputting said tuple as a result to said join query if said tuple meets said one or more conditions to be outputted.

11. The computer-readable storage medium of claim 10, further comprising:
optimizing the join query based on information pertaining to a data source.

12. The computer-readable storage medium of claim 11, wherein said information pertaining to said data source comprises that two or more data streams of said at least one data stream having a same data source.

13. The computer-readable storage medium of claim 10, further comprising:
performing one or more query transformations such that said join query is performed by said one or more low level queries, while a complex analysis is performed by said one or more high level queries.

14. The computer-readable storage medium of claim 10, further comprising:
decomposing said join query if said join query contains a reference to one or more attributes which are not part of a restricted set of attributes of a data stream maintained by a data summary structure.

15. The computer-readable storage medium of claim 14, wherein said decomposing of said join query is performed to use a filter join at said one or more low level queries and a symmetric hash join at said one or more high level queries.

16. The computer-readable storage medium of claim 10, wherein each of said one or more low level queries applies a filter join that is implemented using a hash join algorithm or an approximate filter join algorithm.

17. The computer-readable storage medium of claim 16, wherein said approximate filter join algorithm uses a hash table or a bloom filter as a data summary structure.

18. The computer-readable storage medium of claim 17, further comprising: performing collision handling if a slot of said hash table is occupied by a valid tuple.

19. An apparatus for processing at least one data stream, comprising:
means for receiving at least a join query for the at least one data stream, wherein said join query specifies a lifetime for keeping a tuple as a marker for a beginning of a sequence of interest;
means for receiving a tuple from the at least one data stream;
means for marking said tuple as a beginning of a sequence of interest and storing said tuple in accordance with the lifetime specified in said join query, if said tuple is said beginning of said sequence of interest;
means for applying one or more initial predicates to said tuple;
means for determining if said tuple matched a marked tuple, if said tuple meets the one or more initial predicates.
means for determining if said tuple meets one or more conditions to be outputted, if said tuple meets said one or more initial predicates conditions; and
means for outputting said tuple as a result to said join query if said tuple meets said one or more conditions to be outputted.

20. The apparatus of claim 19, further comprising:
means for optimizing the join query based on information pertaining to a data source.
